(19) United States
(12) Patent Application Publication
(10) Pub. No.: US 2011/0272423 A1
(43) Pub. Date: Nov. 10, 2011

(54) COASTERS FOR BEVERAGE CONTAINERS

(76) Inventor: Idean Fakhri, Torrance, CA (US)

(21) Appl. No.: 12/773,474

(22) Filed: May 4, 2010

(51) Int. Cl. B65D 25/00; B42D 15/00

(52) U.S. Cl. 220/740; 283/56

(57) ABSTRACT

A coaster for a beverage container includes a napkin, a drawstring and a retainer. The napkin may comprise an absorbent material, and may include a bottom side and a top side. The napkin may be configured for draping over a rim of the beverage container such that a portion of the napkin covers the rim when the napkin is draped over the rim. The drawstring may include a first end and a second end, and the first end and the second may extend out from the napkin through at least one opening in the napkin. The retainer may be configured for receiving the first end and the second end of the drawstring, manually tightening the drawstring around an outer surface of the beverage container, and manually loosening the drawstring from around the outer surface of the beverage container.

### BACKGROUND OF THE INVENTION

1. Field of the Invention

The present invention relates to coasters for beverage containers, and more particularly, to coasters that effectively and easily cover and protect beverages from contamination while beverages are left unattended by consumers.

2. Related Art

Many different types of coasters are used by consumers. Coasters exist in various shapes and sizes. Many existing coasters include advertisements. Sometimes, simple napkins are used as coasters to absorb condensation or spills from beverage containers. However, existing coasters fail to provide an effective means for covering beverage containers such as glasses, cups, mugs, bottles, cans and the like; thus, existing coasters fail to provide an effective means for protecting beverages within beverage containers from contamination when consumers leave their beverages unattended, or when consumers otherwise desire to cover their beverages. For example, when a consumer is in a restaurant or bar, the consumer may wish to protect his or her beverage from contamination, such as the illegal placement of drugs in the beverage by other consumers, especially when the consumer's beverage is left unattended. As another example, when a consumer drinks soda outdoors, the consumer may wish to protect his or her beverage from insects, such as bees, when the beverage is left unattended. Some existing coasters may be used to cover beverages, but fail to do so effectively. For example, a simple napkin that is used as a coaster may be placed over a beverage container to cover it, but the napkin may be easily removed.

In view of the foregoing, there is an ongoing need for affordable coasters for beverage containers that may be easily used to effectively cover beverage containers when desired by the consumer.

### SUMMARY

To address the foregoing problems, in whole or in part, and/or other problems that may have been observed by persons skilled in the art, the present disclosure provides methods, apparatus, instruments, and/or devices, as described by way of example in implementations set forth below.

A coaster for a beverage container is provided. According to one implementation, the coaster includes a napkin made of an absorbent material, a drawstring and a retainer. The napkin may include a bottom side and a top side. The drawstring may be located substantially around a perimeter of the napkin. The drawstring may include a first end and a second end that extend out from the napkin through at least one opening in the napkin. The retainer may be configured for receiving the first end and the second end of the drawstring.

The napkin is generally configured for draping over a rim of the beverage container such that a portion of the napkin covers the rim when the napkin is draped over the rim. The retainer may be configured for manually tightening the drawstring around an outer surface of the beverage container, and manually loosening the drawstring from around the outer surface of the beverage container.

According to another implementation, the at least one opening may include a first opening through which the first end of the drawstring extends, and a second opening through which the second end of the drawstring extends.

According to another implementation, the napkin may include a uniform layer of the absorbent material.

According to another implementation, the top side of the napkin may include a top sheet of the absorbent material and the bottom side may include a bottom sheet of the absorbent material. The bottom sheet may be secured to the top sheet and the drawstring may be located between the bottom sheet and the top sheet.

According to another implementation, the top sheet of the napkin may be secured to the bottom sheet so as to form an enclosed pocket substantially located around the perimeter of the napkin. The drawstring may be located within the enclosed pocket, and the first end and the second end may extend out from the napkin through the at least one opening, wherein the opening is located in the pocket.

According to another implementation, the bottom sheet may include a uniform layer of the absorbent material, and the top sheet may include a uniform layer of the absorbent material.

According to another implementation, the portion of the napkin that covers the rim of the beverage container when the napkin is draped over the rim of the beverage container includes a plurality of layers of the absorbent material.

According to another implementation, the absorbent material may include paper or reusable cotton fabric, for example.

According to another implementation, the napkin may include printed advertisements thereon.

According to another implementation, a method is provided for covering a beverage container. The method includes draping a coaster for the beverage container over a rim of the beverage container such that a portion of the coaster covers the rim of the beverage container; and manipulating a retainer that receives a first end and a second end of a drawstring of the coaster to manually tighten the drawstring around an outer surface of the beverage container.

According to another implementation, the method for covering the beverage container may further include manipulating the retainer to manually loosen the drawstring from around the outer surface of the beverage container; and removing the coaster from the rim of the beverage container.

According to another implementation, the method may further include setting the beverage container on the coaster.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a top plan view of an implementation of a coaster according to the present invention.

FIG. 2 is a top plan view of another implementation of a coaster according to the present invention.

FIG. 3 is a top plan view of another implementation of a coaster according to the present invention.

FIG. 4 is a top plan view of another implementation of a coaster according to the present invention.

FIG. 5 is an elevation view of a coaster according to the present invention draped over a beverage container.

FIG. 6 is a flow diagram illustrating a method for covering a beverage container according to the present invention.

### DETAILED DESCRIPTION

The description of implementations below is presented for purposes of illustration. It is not exhaustive and does not limit the claimed invention to the precise form disclosed. Modifications and variations are possible in light of the description below, or may be acquired from practicing the invention. The claims and their equivalents define the scope of the invention.

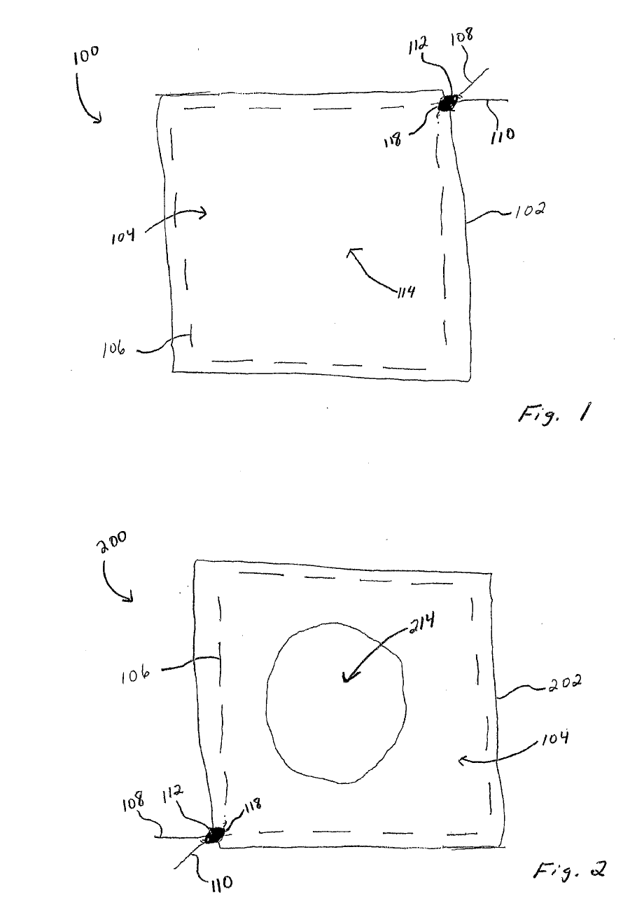

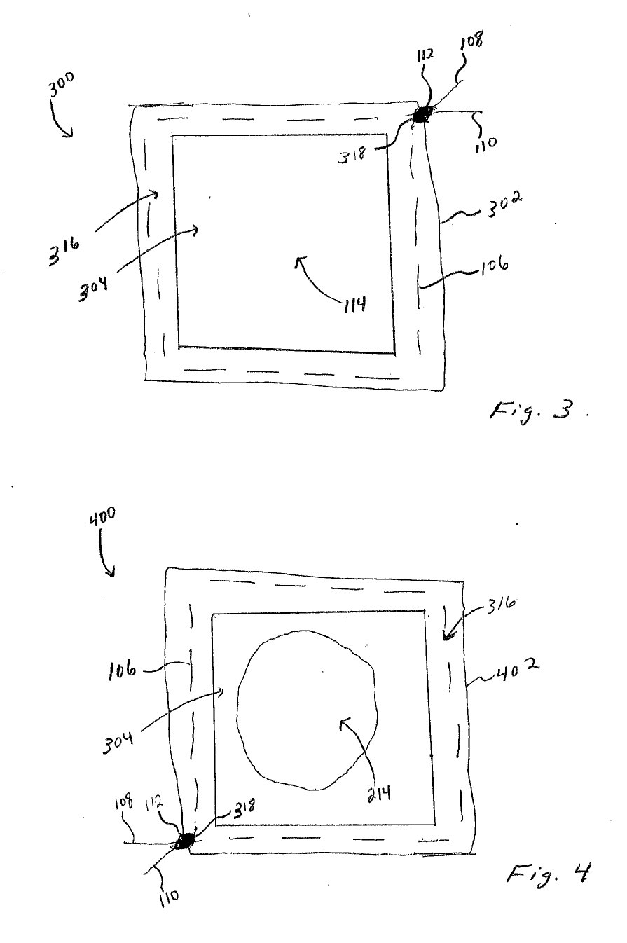

FIG. 1 is a top plan view of an implementation of a coaster 100 for a beverage container (not shown) according to the present invention. The coaster 100 generally includes a napkin 102, a drawstring 106 and a retainer 112. The napkin 102 generally includes a bottom side (not shown) and a top side 104, and the napkin 102 may be configured for draping over a rim of the beverage container such that a portion 114 of the napkin 102 covers the rim when the napkin 102 is draped over the rim. The napkin 102 may be made of an absorbent material, such as paper. In some implementations, the napkin 102 may be made of reusable, washable fabric, such as cotton, silk, velvet, or rayon fabric or various other textiles including synthetic and natural absorbent materials. In some implementations, the napkin 102 may include a uniform layer of the absorbent material. In some implementations the napkin 102 may include a plurality of layers of the absorbent material. For example, in implementations in which the napkin 102 includes a plurality of layers of the absorbent material, the bottom side of the napkin 102 may comprise a bottom sheet of the absorbent material, and the top side 104 of the napkin 102 may comprise a top sheet of the absorbent material. In some implementations, the bottom sheet may include a first uniform layer of the absorbent material, and the top sheet may include a second uniform layer of the absorbent material. In some implementations, there may be additional layers of the absorbent material between the top sheet and the bottom sheet. In implementations in which the top side 104 comprises a top sheet and the bottom side comprises a bottom sheet, the top sheet may be secured to the bottom sheet by any suitable means. For example, the top sheet may be stitched to the bottom sheet; adhesive may be present between the top sheet and the bottom sheet; or interactions between paper fibers in the top sheet and paper fibers in the bottom sheet may provide for the securing of the top sheet to the bottom sheet. Examples in which a plurality of absorbent layers is present in a napkin 202 according to the present invention are discussed in further detail below with respect to FIG. 2. In some implementations, the napkin 102 may include printed advertisements, or decorative printings thereon. The napkin 102 may be any shape, such as circular, square (as shown), or rectangular.

The drawstring 106 may generally be threaded between the bottom side and the top side 104 of the napkin 102, and may be located substantially around a perimeter of the napkin 102. The drawstring 106 may include a first end 108 and a second end 110, and the first end 108 and the second end 110 may extend out from the napkin 102 through at least one opening 118 in the napkin 102. In one example, the at least one opening 118 may include a first opening through which the first end 108 extends, and a second opening through which the second end 110 extends. In implementations in which the top side 104 comprises a top sheet and the bottom side comprises a bottom sheet, the drawstring 106 may be sandwiched between the top sheet and the bottom sheet, and the first end 108 and the second end 110 may extend out from between the bottom sheet and the top sheet through at least one opening located between the bottom sheet and the top sheet. The drawstring 106 may be made of string, twine, plastic, or any other suitable material.

The retainer 112 may be configured for receiving the first end 108 and the second end 110 of the drawstring 106, manually tightening the drawstring 106 around an outer surface of the beverage container, and manually loosening the drawstring 106 from around the outer surface of the beverage container. The retainer 112 in the present example may include any one of a plurality of retainers known to those skilled in the art. For example, the retainer 112 may include a slidably adjustable retainer such that the drawstring 106 may be tightened around the outer surface of the beverage container, or loosened from around the outer surface of the beverage container, by sliding the retainer 112 towards, or away from, the outer surface of the beverage container. As another example, the retainer 112 may be configured such that the drawstring may be tightened around the outer surface of the beverage container by pulling either (or both) the first end 108 or the second end 110 through the retainer 112.

The coaster 100 according to the present invention may be used in conjunction with a variety of different beverage containers, including glasses, jars, cups, bottles, cans, etc. The beverage container may be set on the coaster 100. Alternatively, the coaster 100 may be used to cover the beverage container when a consumer leaves the beverage container unattended, or when the consumer otherwise desires to easily and effectively cover the beverage container. For example, the consumer may wish to cover the beverage container with the coaster 100 to keep insects such as bees out of the beverage container. As another example, the consumer may wish to deter others from contaminating his or her beverage by, for example, illegally placing drugs or other substances in the beverage container when the consumer is not paying particularly close attention to his or her beverage. The coaster 100 may be used to cover the consumer's beverage container in such circumstances.

FIG. 2 is a top plan view of another implementation of a coaster 200 according to the present invention. The coaster 200 may be utilized as described above in conjunction with FIG. 1, or as otherwise described herein. In the present example illustrated in FIG. 2, a portion 214 of a napkin 202 that covers the rim of the beverage container when the napkin 202 is draped over the rim includes a plurality of layers of the absorbent material. The plurality of layers of the absorbent material may be arranged in a variety of ways. For example, the top side 104 may include more than one layer (e.g., multiple sheets) of the absorbent material, and the bottom side may include a uniform layer of the absorbent material. As another example, the bottom side may include more than one layer of the absorbent material and the top side 104 may include a uniform layer of the absorbent material. As yet another example, the top side 104 may include a uniform layer of the absorbent material and the bottom side may include a uniform layer of the absorbent material, and at least one layer of absorbent material may be disposed between the bottom side and the top side. Various other configurations for the portion 214 of the napkin 202 that covers the rim of the beverage container when the napkin 202 is draped over the rim of the beverage container may be contemplated by those skilled in the art.

FIG. 3 is a top plan view of another implementation of a coaster 300 according to the present invention. The coaster 300 may be utilized as described above in conjunction with FIGS. 1-2, or as otherwise described herein. In the present example illustrated in FIG. 3, a napkin 302 includes a top side 304 comprising a top sheet of absorbent material secured to a bottom side comprising a bottom sheet of absorbent material. The top sheet may be secured to the bottom sheet so as to form an enclosed pocket 316 substantially located around a perimeter of the napkin 302. The drawstring 106 may be located within the enclosed pocket 316, and the first end 108 and the second end 110 of the drawstring may extend through at least one opening 318 in the pocket 316. As discussed above in conjunction with FIG. 1, the top sheet 304 may be secured to the bottom sheet by any suitable means, such as stitching, adhesive, interactions between paper fibers, etc.

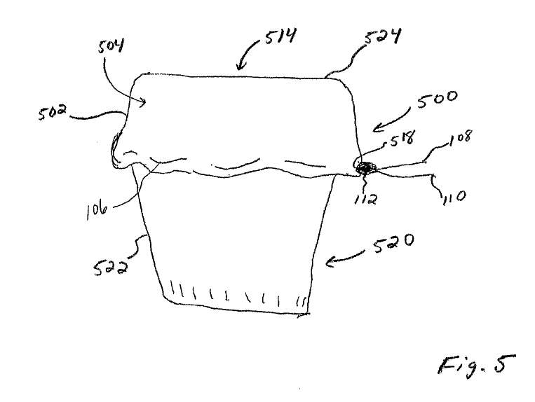

FIG. 4 is a top plan view of another implementation of a coaster 400 according to the present invention. The coaster 400 may be utilized as described above in conjunction with FIGS. 1-3, or as otherwise described herein. In the present example illustrated in FIG. 4, the portion 214 of a napkin 402 that covers the rim of the beverage container when the napkin 402 is draped over the rim includes a plurality of layers of the absorbent material. The plurality of layers of the absorbent material may be arranged in a variety of ways, as discussed above in conjunction with FIG. 2. In the present example, the coaster 400 includes the enclosed pocket 316 substantially located around a perimeter of the napkin 402, described above in conjunction with FIG. 3.

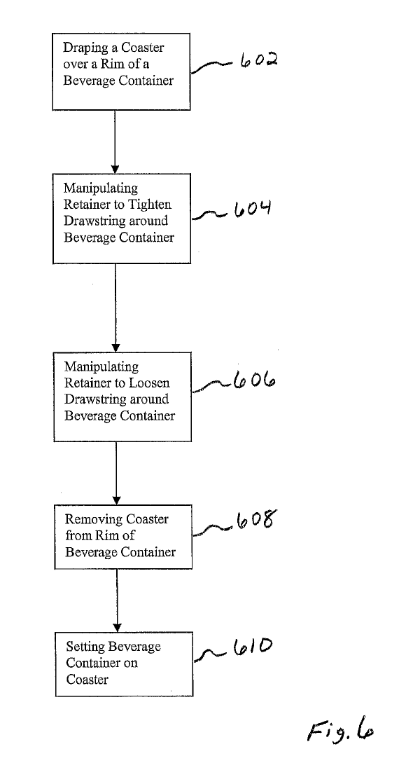

FIG. 5 is an elevation view of a coaster 500 according to the present invention draped over a rim 524 of a beverage container 520. The coaster 500 includes a napkin 502, the drawstring 106, and the retainer 112. The napkin 502 may be configured as described above with respect to FIGS. 1-4. For example, the napkin 502 may include a top side 504 and a bottom side (not shown), and the napkin 502 may be draped over the rim 524 of the beverage container such that a portion 514 of the napkin covers the rim 524. As illustrated in FIG. 5, the first end 108 and the second end 110 of the drawstring 106 extend out from the napkin 502 through at least one opening 518. The drawstring 106 may be threaded between the top side 504 and the bottom side of the napkin 502, and the drawstring may be substantially located around a perimeter of the napkin 502. The retainer 112 receives the first end 108 and the second end 110 of the drawstring 106, and the retainer 112 may be configured for manually tightening the drawstring 106 (e.g., tightening the drawstring 106 through an action by the consumer such as sliding or pulling the retainer 112 and/or pulling the first end 108 and/or the second end 110 through the retainer 112) around an outer surface 522 of the beverage container 520. The retainer 112 may also be configured for manually loosening the drawstring 106 from around the outer surface 522 of the beverage container 520.

FIG. 6 is a flow diagram illustrating a method for covering a beverage container according to the present invention. The method may be implemented by utilizing a coaster 100 or 200 or 300 or 400 or 500 such as described above and illustrated in FIGS. 1-5. The first step 602 in the method generally includes draping a coaster over a rim of the beverage container such that a portion of the coaster covers the rim. The second step 604 in the present example includes manipulating a retainer that receives a first end and a second end of a drawstring of the coaster to manually tighten the drawstring around an outer surface of the beverage container. As described above, the coaster may include a napkin, the drawstring and the retainer. The napkin may comprise an absorbent material, and may include a bottom side and a top side. The drawstring may generally be threaded between the bottom side and the top side of the napkin, and may be located substantially around a perimeter of the napkin. The first end and the second end of the drawstring may extend out from the napkin through at least one opening, and through the retainer. The third step 606 of the present example includes manipulating the retainer to manually loosen the drawstring from around the outer surface of the beverage container. For example, the drawstring may be loosened by slidably adjusting the retainer and/or pulling the first end and/or the second end of the drawstring back through the retainer. The fourth step 608 in the present example includes removing the coaster from the rim of the beverage container. The fifth step 610 in the present example includes setting the beverage container on the coaster. In other implementations, the steps of the present method may be implemented in various combinations. In some implementations, all of the steps illustrated in FIG. 6 may not be required.

In general, terms such as “coupled to,” and “configured for coupling to,” and “secured to,” and “in communication with” (for example, a first component is “coupled to” or “is configured for coupling to” or is “secured to” or is “in communication with” a second component) are used herein to indicate a structural, functional, mechanical, electrical, signal, optical, magnetic, electromagnetic, ionic or fluidic relationship between two or more components or elements. As such, the fact that one component is said to be in communication with a second component is not intended to exclude the possibility that additional components may be present between, and/or operatively associated or engaged with, the first and second components.

It will be understood that various aspects or details of the invention may be changed without departing from the scope of the invention. Furthermore, the foregoing description is for the purpose of illustration only, and not for the purpose of limitation—the invention being defined by the claims.

What is claimed is:

1. A coaster for a beverage container, comprising:
a napkin comprising an absorbent material, the napkin including a bottom side and a top side, wherein the napkin is configured for draping over a rim of the beverage container such that a portion of the napkin covers the rim when the napkin is draped over the rim;
a drawstring located substantially around a perimeter of the napkin, the drawstring including a first end and a second end, wherein the first end and the second end extend out from the napkin through at least one opening in the napkin; and
a retainer configured for receiving the first end and the second end of the drawstring, manually tightening the drawstring around an outer surface of the beverage container, and manually loosening the drawstring from around the outer surface of the beverage container.

2. The coaster of claim 1, wherein the at least one opening includes a first opening through which the first end extends, and a second opening through which the second end extends.

3. The coaster of claim 1, wherein the napkin includes a uniform layer of the absorbent material.

4. The coaster of claim 1, wherein:
the top side of the napkin includes a top sheet of the absorbent material;
the bottom side includes a bottom sheet of the absorbent material,
the bottom sheet is secured to the top sheet; and
the drawstring is located between the bottom sheet and the top sheet.

5. The coaster of claim 4, wherein:
the top sheet is secured to the bottom sheet so as to form an enclosed pocket substantially located around the perimeter of the napkin; and
the drawstring is located within the enclosed pocket, and the first end and the second end extend through the at least one opening, wherein the at least one opening is located in the pocket.

6. The coaster of claim 4, wherein the bottom sheet comprises a first uniform layer of the absorbent material, and the top sheet comprises a second uniform layer of the absorbent material.

7. The coaster of claim 1, wherein the portion of the napkin that covers the rim when the napkin is draped over the rim includes a plurality of layers of the absorbent material.

8. The coaster of claim 1, wherein the portion of the napkin that covers the rim when the napkin is draped over the rim includes a plurality of layers of the absorbent material.

9. The coaster of claim 1, further comprising a plurality of layers of absorbent material disposed between the top side and the bottom side of the napkin.

10. The coaster of claim 1, wherein the napkin is made of an absorbent material selected from the group consisting of paper, reusable cotton fabric, silk, velvet, rayon and combinations thereof.

11. The coaster of claim 1, wherein the napkin includes printed advertisements thereon.

12. A coaster for a beverage container, comprising:
a napkin comprising an absorbent material, the napkin including a bottom sheet and a top sheet secured to the bottom sheet, wherein the napkin is configured for draping over a rim of the beverage container such that a portion of the napkin covers the rim when the napkin is draped over the rim;
a drawstring located between the bottom sheet and the top sheet and substantially around a perimeter of the napkin, the drawstring including a first end and a second end, wherein the first end and the second end extend out from between the bottom sheet and the top sheet through at least one opening; and
a retainer configured for receiving the first end and the second end of the drawstring, manually tightening the drawstring around an outer surface of the beverage container, and manually loosening the drawstring from around the outer surface of the beverage container.

13. The coaster of claim 12, wherein:
the top sheet is secured to the bottom sheet so as to form an enclosed pocket substantially located around the perimeter of the napkin; and
the drawstring is located within the enclosed pocket, and the first end and the second end extend through the at least one opening, wherein the at least one opening is located in the pocket.

14. A method for covering a beverage container, the method comprising:
draping a coaster over a rim of the beverage container such that a portion of the coaster covers the rim, wherein the coaster comprises:
a napkin comprising an absorbent material, the napkin including a bottom side and a top side;
a drawstring located substantially around a perimeter of the napkin, the drawstring including a first end and a second end, wherein the first end and the second end extend out from the napkin through at least one opening in the napkin; and
a retainer configured for receiving the first end and the second end of the drawstring;
and
manipulating the retainer to manually tighten the drawstring around an outer surface of the beverage container.

15. The method of claim 14, further comprising:
manipulating the retainer to manually loosen the drawstring from around the outer surface of the beverage container; and
removing the coaster from the rim of the beverage container.

16. The method of claim 15, further comprising setting the beverage container on the coaster.
